(19) United States
(12) Patent Application Publication
(10) Pub. No.: US 2005/0200804 A1
(43) Pub. Date: Sep. 15, 2005

(54) Nose pad assembly

(75) Inventor: Hiroyuki Kawabata, Fukui (JP)

Correspondence Address: BACON & THOMAS, PLLC, 625 SLATERS LANE, FOURTH FLOOR, ALEXANDRIA, VA, 22314, US

(73) Assignee: SASAMATA Company, Limited, Fukui (JP)

(21) Appl. No.: 10/911,609

(22) Filed: Aug. 5, 2004

(30) Foreign Application Priority Data
Mar. 11, 2004 (JP) 2004-069080

(51) Int. Cl. G02C 1/00

(52) U.S. Cl. 351/70

(57) ABSTRACT

A nose pad assembly to be mounted to the front portion of an eyeglass frame. The nose pad assembly includes a pad leg, a nose pad to be mounted to a first end of the pad leg, and a base integrated with a second end of the pad leg and integrated with the front portion with an adhesive etc. Since the nose pad assembly can be mounted to any position on the back of the front portion 17 by joining the base to the back of the front portion with an adhesive etc., the position to mount the nose pads, the angle of the nose pads, etc. can be set depending on the size, height, etc. of a consumer's nose, thus providing all consumers with a comfortable feeling to wear.

### BACKGROUND OF THE INVENTION

1. Field of the Invention

The present invention relates to a nose pad assembly and, more particularly, to a nose pad assembly in which the nose-pad mounting position and mounting angle to the front of an eyeglass frame, etc. can be set and also the nose-pad mounting position and mounting angle can be finely adjusted.

2. Description of the Related Art

Eyeglass frames are composed of multiple components, such as a pair of lens-retaining frames, a bridge connecting the inner rims of the lens-retaining frames together, and temples closably connected to the outer rims of the lens-retaining frames with hinges.

The front portion (the bridge and the lens-retaining frames) of the eyeglass frame including the multiple components has a pair of nose pads and as such, when the eyeglass frame is put on a face, the pair of nose pads is brought into contact with the opposite sides of the nose and both the temples are retained to both ears, thereby retaining the eyeglass frame in position on the face.

Of the eyeglass frames with the foregoing structure, resin eyeglass frames are constructed such that opposite lens-retaining frames and the bridge at the front portion are integrated and nose pads are integrated with the inner rims of the lens-retaining frames with an adhesive etc.

Accordingly, the nose-pad mounting position, the interval between the nose pads, the mounting angle, etc. are set at the manufacturing stage, so that, at the time of purchase, consumers cannot set the nose-pad mounting position, the interval between the nose pads, the mounting angle, etc. depending on the size, height, etc. of their noses. This hinders all people from enjoying comfortable feeling to wear (refer to Japanese Unexamined Patent Application Publication No. 2000-292606).

### SUMMARY OF THE INVENTION

The present invention has been made to solve the above-describe problems. Accordingly, it is an object of the present invention to provide a nose pad assembly in which the nose-pad mounting position, the interval between the nose pads, the mounting angle, etc. can be set depending on the size and height of consumers' noses, etc., thus giving all people comfortable feeling to wear.

In order to achieve the above object, according to embodiments of the present invention, there is provided a nose pad assembly to be mounted to the front portion of an eyeglass frame, comprising: a pad leg; a nose pad to be mounted to a first end of the pad leg; and a base integrated with a second end of the pad leg and integrated with the front portion with joining means.

Preferably, in the nose pad assembly according to the present invention, the joining means is an adhesive.

Preferably, in the nose pad assembly according to the present invention, the pad leg has a pad-mounting portion at the first end, wherein the nose pad is mounted to the pad-mounting portion through pad-mounting means.

Preferably, in the nose pad assembly according to the present invention, the pad-mounting means is a cored bar provided to the nose pad, the bar being fixed to the pad-mounting portion with a screw.

Preferably, in the nose pad assembly according to the present invention, the pad-mounting means is a groove provided to the nose pad for the pad-mounting portion to fit in.

Preferably, in the nose pad assembly according to the present invention, the pad-mounting portion has a spring force.

Preferably, in the nose pad assembly according to the present invention, the pad-mounting portion has at least one projection or recess and wherein the nose pad has a recess or a projection to be fitted to the projection or the recess at the part of the groove corresponding to the projection or the recess.

As set forth hereinabove, according to the invention, the base at the second end of the pad leg is integrated with the front portion with joining means. Accordingly, the interval between the nose pads, the angle of the nose pads, etc. can be adjusted by adjusting the joint position of the base of the pad leg to the front portion depending on the size, height, etc. of a consumer's nose. The nose pad assembly can therefore provide all consumers with a comfortable feeling to wear.

Furthermore, since the nose pad can be mounted to the pad-mounting portion of the pad leg through the pad-mounting means, the nose pad can easily be mounted.

### BRIEF DESCRIPTION OF THE DRAWINGS

FIG. 1 is a perspective view of a nose pad assembly according to a first embodiment of the present invention;

FIG. 2 is a perspective view of the nose pad assembly of FIG. 1, showing the state before and after the nose pad assembly is mounted to the front portion of an eyeglass frame;

FIG. 3 is a perspective view of a nose pad assembly according to a second embodiment of the present invention;

FIG. 4 is a cross-sectional view of the pad-mounting portion of FIG. 3;

FIG. 5 is an explanatory diagram of a modification of the nose pad assembly according to the second embodiment, showing part of a pad leg;

FIG. 6 is a is an explanatory diagram of a modification of the nose pad assembly according to the second embodiment, showing a pad in perspective;

FIG. 7 is an explanatory diagram of a modification of the nose pad assembly according to the second embodiment, showing a pad in perspective;

FIG. 8 is an explanatory diagram of a modification of the nose pad assembly according to the second embodiment, showing part of a pad leg;

FIG. 9 is a cross-sectional view of the pad-mounting portion of FIG. 8; and

FIG. 10 is a partial view of a modification of the nose pad assembly according to the second embodiment.

### DESCRIPTION OF THE PREFERRED EMBODIMENTS

Embodiments of the present invention will be described hereinafter with reference to the drawings.

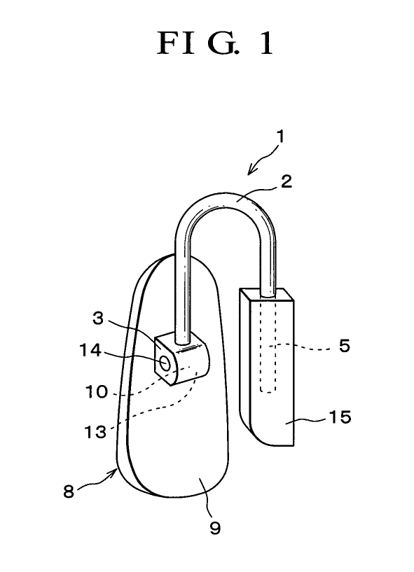

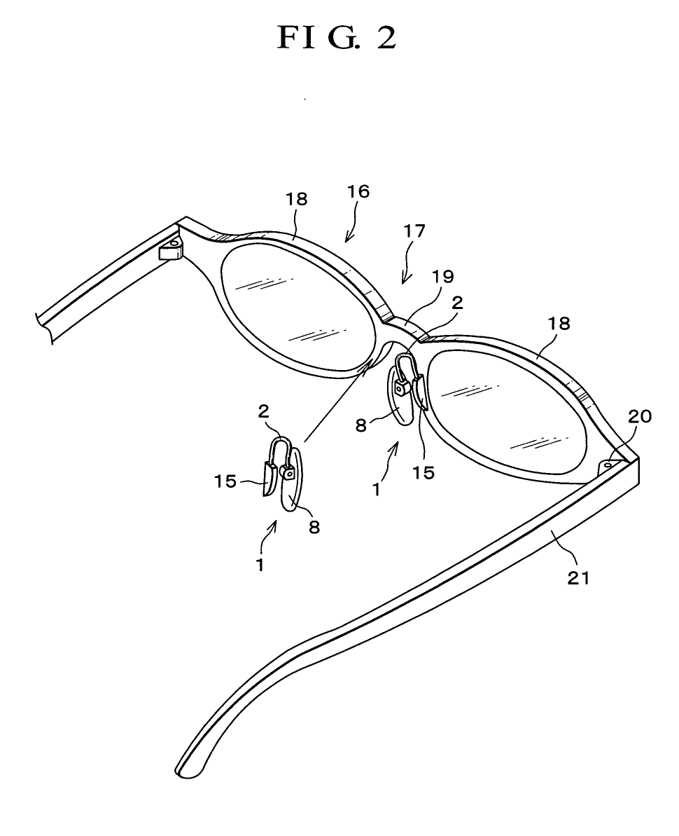

FIG. 1 is a perspective view of the entire nose pad assembly according to a first embodiment of the present invention. FIG. 2 is a perspective view of the nose pad assembly of FIG. 1, showing the state before and after the nose pad assembly of FIG. 1 is mounted to the front portion of an eyeglass frame.

A nose pad assembly 1 according to the first embodiment includes a pad leg 2, a nose pad 8 to be mounted to a first end of the pad leg 2, and a base 15 integrated with a second end of the pad leg 2.

The pad leg 2 is made of a synthetic-resin or metal round wire rod. The wire rod is bent at the center to form a substantially U shape. A box-shaped pad-mounting portion 3 is integrated with the first end of the U-shaped wire rod. A base-mounting portion 5 is integrated with the second end.

A nose pad 8 is mounted to the pad-mounting portion 3 of the pad leg 2 with pad-mounting means 13. The pad-mounting means 13 is a cored bar 10 provided to the nose pad 8, to be described later. The cored bar 10 is fixed to the pad-mounting portion 3 with a screw 14 to mount the nose pad 8 to the pad leg 2.

The nose pad 8 includes a pad 9 made of silicon etc. and the metal cored bar 10 integrated with the pad 9. The nose pad 8 is mounted to the first end of the pad leg 2 by fixing the cored bar 10 to the pad-mounting portion 3 of the pad leg 2 with the screw 14.

A substantially rectangular-prism-shaped base 15 made of synthetic resin or metal is integrated with the base-mounting portion 5 of the pad leg 2. The base 15 can be integrated with the base-mounting portion 5 of the pad leg 2, if made of resin; when it is made of metal, the base 15 can be integrated with the base-mounting portion 5 of the pad leg 2 by welding etc.

As shown in FIG. 2, an eyeglass frame 16 includes multiple components such as a pair of lens-retaining frames 18, a bridge 19 connecting the inner rims of the lens-retaining frames 18 together, and temples 21 closably connected to the outer rims of the lens-retaining frames 18 with hinges 20. The components of the eyeglass frame 16 are made of various resins or metals.

The pair of lens-retaining frames 18 and the bridge 19 construct a front portion 17. The base 15 of the nose pad assembly 1 is integrated with the back of each lens-retaining frame 18 at the front portion 17 with joining means. The joining means includes various adhesives, which may be selected depending on the material of the base 15.

The nose pad assembly 1 according to the embodiment with such a structure can be mounted to any position on the back of the front portion 17 by joining the base 15 with the back of the front portion 17 with an adhesive etc. Accordingly, the mounting position and angle of the nose pad 8 can be set depending on the size, height, etc. of a consumer's nose, allowing the nose pad assembly 1 to provide all consumers with a comfortable feeling to wear.

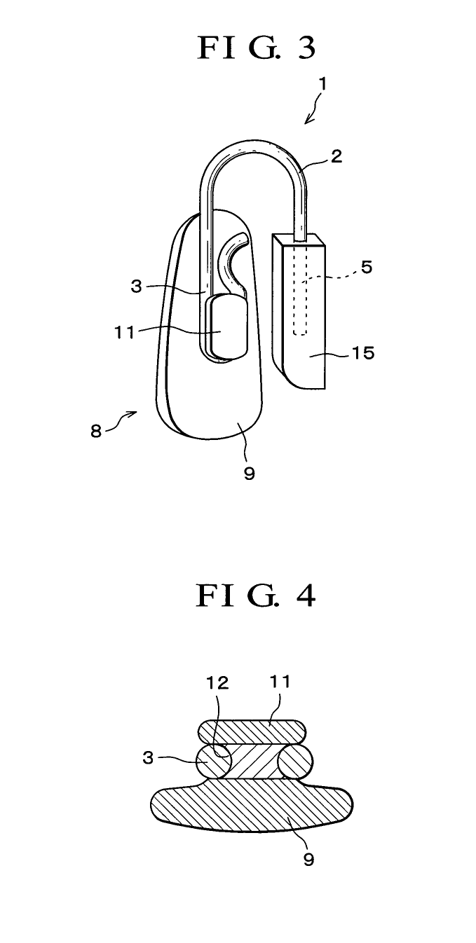

FIG. 3 shows a nose pad assembly according to a second embodiment of the present invention. In the nose pad assembly 1, the pad leg 2 is made of a synthetic-resin or metal wire rod. The wire rod is bent at the center to form a substantially U shape. A first end of the substantially U-shaped rod is further bent inwardly to form a substantially U shape, thereby forming the pad-mounting portion 3. Other structures are the same as those of the first embodiment.

The nose pad 8 is mounted to the pad-mounting portion 3 with pad-mounting means 13, as in the first embodiment. The pad-mounting means 13 is a groove 12 provided to the nose pad 8, to be described later, for the substantially U-shaped pad-mounting portion 3 to fit in.

As shown in FIG. 3, the nose pad 8 includes the pad 9 made of silicon etc. and a leg 11 integrated with the pad 9. As shown in FIG. 4, a groove 12 of a specified width and depth is provided around the whole circumference of the base of the leg 11, which serves as the pad-mounting means 13. The nose pad 8 is mounted to the pad leg 2 by fitting the pad-mounting portion 3 of the pad leg 2 into the groove 12. In this case, the pad-mounting portion 3 of the pad leg 2 may have a spring force to bring the pad-mounting portion 3 into pressure contact with the bottom of the groove 12. Such a structure effectively prevents the nose pad 8 from coming off from the pad leg 2.

Also when the nose pad assembly 1 according to this embodiment with such a structure is mounted to the front portion 17 of the eyeglass frame 16, shown in FIG. 2, the nose pad assembly 1 can be mounted to any position on the back of the front portion 17 by joining the base 15 to the back of the front portion 17 with an adhesive etc., as in the first embodiment. Accordingly, the mounting position and angle of the nose pad 8 can be set depending on the size, height, etc. of a consumer's nose, allowing the nose pad assembly 1 to provide all consumers with a comfortable feeling to wear.

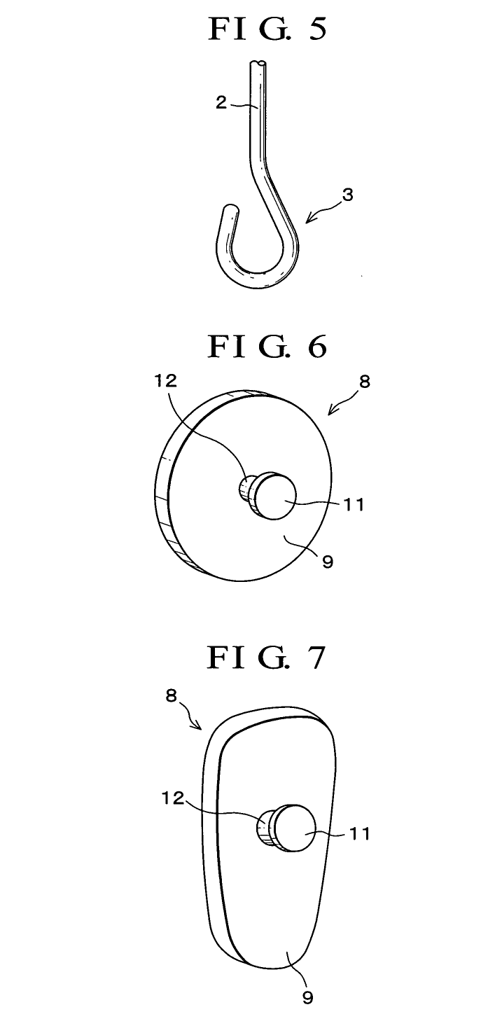

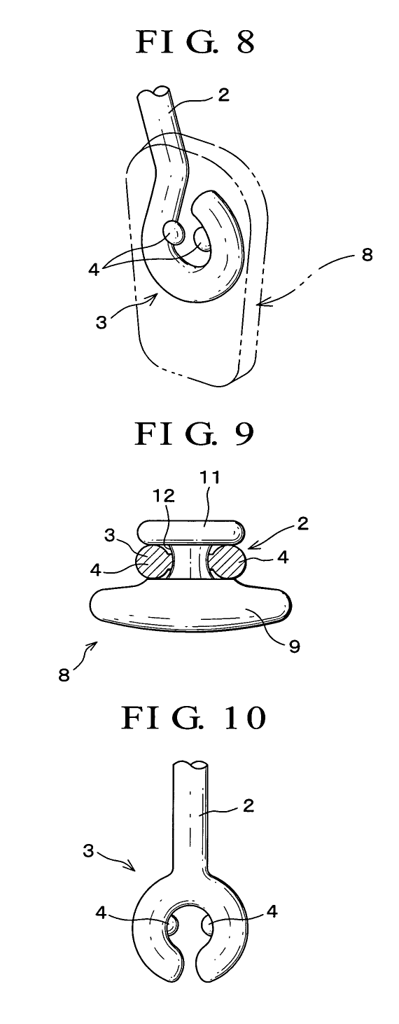

FIGS. 5 to 10 show modifications of the nose pad assembly 1 according to a second embodiment.

The nose pad assembly 1 shown in FIGS. 5 and 6 is constructed such that the pad-mounting portion 3 of the pad leg 2 is shaped in substantially a ring shape which is open at the top, the nose pad 8 has the cylindrical leg 11 in the center of the disc-shaped pad 9 integrated therewith, and the groove 12 of a specified depth is provided around the whole circumference of the base of the leg 11. In this case, the groove 12 of the nose pad 8 serves as the pad-mounting means 13.

The nose pad assembly 1 shown in FIGS. 7 to 9 is constructed such that the pad-mounting portion 3 of the pad leg 2 is shaped in substantially a ring shape which is open at the top and the inner surface of the pad-mounting portion 3 is provided with a pair of projections 4. The nose pad 8 is integrated with the cylindrical leg 11 in the center of the elliptical-plate-shaped pad 9 and the groove 12 of a specified depth is provided around the whole circumference of the base of the leg 11. In this case, the groove 12 of the nose pad 8 serves as the pad-mounting means 13. The pair of projections 4 at the pad-mounting portion 3 is in pressure contact with the bottom of the groove 12. The pad-mounting portion 3 may have a spring force to bring the pair of projections 4 strongly into pressure contact with the bottom of the groove 12.

Although not shown, the part of the groove 12 corresponding to the projections 4 may have recesses (not shown) for the projections 4 to fit in. Alternatively, the groove 12 may have projections (not shown) and the pad-mounting portion 3 may have recesses (not shown) at part corresponding to the projections, for the projections to fit in.

The nose pad assembly 1 shown in FIG. 10 includes the pad leg 2 having the substantially ring-shaped pad-mounting portion 3 which is open at the bottom and the pair of projections 4 provided on the inner surface of the pad-mounting portion 3.

The nose pad assembly 1 according the modifications also offers the same advantages as those of the first and second embodiments.

1. A nose pad assembly to be mounted to the front portion of an eyeglass frame, comprising:
a pad leg;
a nose pad to be mounted to a first end of the pad leg; and
a base integrated with a second end of the pad leg and integrated with the front portion with joining means.

2. A nose pad assembly according to claim 1, wherein the joining means includes an adhesive.

3. A nose pad assembly according to claim 1, wherein the pad leg has a pad-mounting portion at the first end, wherein the nose pad is mounted to the pad-mounting portion through pad-mounting means.

4. A nose pad assembly according to claim 2, wherein the pad leg has a pad-mounting portion at the first end, wherein the nose pad is mounted to the pad-mounting portion through pad-mounting means.

5. A nose pad assembly according to claim 3, wherein the pad-mounting means includes a cored bar provided to the nose pad, the bar being fixed to the pad-mounting portion with a screw.

6. A nose pad assembly according to claim 4, wherein the pad-mounting means includes a cored bar provided to the nose pad, the bar being fixed to the pad-mounting portion with a screw.

7. A nose pad assembly according to claim 3, wherein the pad-mounting means includes a groove provided to the nose pad for the pad-mounting portion to fit in.

8. A nose pad assembly according to claim 4, wherein the pad-mounting means includes a groove provided to the nose pad for the pad-mounting portion to fit in.

9. A nose pad assembly according to claim 7, wherein the pad-mounting portion has a spring force.

10. A nose pad assembly according to claim 8, wherein the pad-mounting portion has a spring force.

11. A nose pad assembly according to claim 7, wherein the pad-mounting portion has at least one projection or recess and wherein the nose pad has a recess or a projection to be fitted to the projection or the recess at the part of the groove corresponding to the projection or the recess.

12. A nose pad assembly according to claim 8, wherein the pad-mounting portion has at least one projection or recess and wherein the nose pad has a recess or a projection to be fitted to the projection or the recess at the part of the groove corresponding to the projection or the recess.

13. A nose pad assembly according to claim 9, wherein the pad-mounting portion has at least one projection or recess and wherein the nose pad has a recess or a projection to be fitted to the projection or the recess at the part of the groove corresponding to the projection or the recess.

14. A nose pad assembly according to claim 10, wherein the pad-mounting portion has at least one projection or recess and wherein the nose pad has a recess or a projection to be fitted to the projection or the recess at the part of the groove corresponding to the projection or the recess.
